(19) United States
(12) Patent Application Publication
(10) Pub. No.: US 2013/0058601 A1
(43) Pub. Date: Mar. 7, 2013

(54) HYDRODYNAMIC BEARING ASSEMBLY AND SPINDLE MOTOR INCLUDING THE SAME

(71) Applicant: Ki Hyung KIM, Seoul (KR)

(72) Inventor: Ki Hyung KIM, Seoul (KR)

(73) Assignee: SAMSUNG ELECTRO-MECHANICS CO., LTD., Suwon (KR)

(21) Appl. No.: 13/595,064

(22) Filed: Aug. 27, 2012

(30) Foreign Application Priority Data
Sep. 5, 2011 (KR) 10-2011-0089603

(51) Int. Cl. F16C 32/06

(52) U.S. Cl. 384/115

(57) ABSTRACT

There are provided a hydrodynamic bearing assembly and a spindle motor including the same. The hydrodynamic bearing assembly includes: a shaft; a sleeve including a shaft hole so that the shaft is rotatably inserted thereinto; and first and second dynamic pressure generation grooves formed in upper and lower portions of at least one of an outer diameter of the shaft and an inner diameter of the sleeve in an axial direction thereof so as to generate dynamic pressure in a lubricating fluid filling a bearing clearance formed between the shaft and the sleeve at the time of rotation of the shaft, wherein the bearing clearance between the shaft and the sleeve is narrowed downwardly in the axial direction.

### CROSS-REFERENCE TO RELATED APPLICATIONS

This application claims the priority of Korean Patent Application No. 10-2011-0089603 filed on Sep. 5, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a spindle motor including the same.

2. Description of the Related Art

A hard disk drive (HDD), an information storage device, reads data stored on a disk or writes data to a disk using a read/write head.

The hard disk drive requires a disk driving device capable of driving the disk. As the disk driving device, a small-sized spindle motor is used.

The small-sized spindle motor commonly uses a hydrodynamic bearing assembly. A lubricating fluid is interposed between a shaft and a sleeve of the hydrodynamic bearing assembly, such that the shaft is supported by fluid dynamic pressure generated in the lubricating fluid.

In this case, two dynamic pressure generation grooves are generally formed in upper and lower portions of the shaft and the sleeve in an axial direction thereofto form at least two bearing parts, thereby allowing the shaft to rotate stably. That is, at the time of the driving of the motor, the lubricating fluid stored between the shaft and the sleeve is concentrated in the dynamic pressure generation grooves, such that at least two bearing parts are formed.

However, when the lubricating fluid between the two dynamic pressure generation grooves is excessively pumped to the two dynamic pressure generation grooves, due to an error in manufacturing, vibrations, external impacts, or the like, the amount of lubricating fluid in a bearing clearance between the two dynamic pressure generation grooves may become insufficient, such that negative pressure is generated. When the negative pressure is generated, noise, vibrations, or the like, are generated within the motor, such that the motor may be operated unstably.

Therefore, research into a new bearing assembly structure, capable of improving operational performance of a motor and preventing the generation of negative pressure has been urgently demanded.

### SUMMARY OF THE INVENTION

An aspect of the present invention provides a hydrodynamic bearing assembly capable of improving the performance of a motor by preventing the generation of negative pressure.

Another aspect of the present invention provides a motor that may be stably used even in the case that vibrations, external impacts, and the like, are applied thereto.

According to an aspect of the present invention, there is provided a hydrodynamic bearing assembly including: a shaft; a sleeve including a shaft hole so that the shaft is rotatably inserted thereinto; and first and second dynamic pressure generation grooves formed in upper and lower portions of at least one of an outer diameter of the shaft and an inner diameter of the sleeve in an axial direction thereof so as to generate dynamic pressure in a lubricating fluid filling a bearing clearance formed between the shaft and the sleeve at the time of rotation of the shaft, wherein the bearing clearance between the shaft and the sleeve is narrowed downwardly in the axial direction.

The outer diameter of the shaft or the inner diameter of the sleeve may be tapered in the axial direction.

The outer diameter of the shaft or the inner diameter of the sleeve may be tapered downwardly from a portion between the first and second dynamic pressure generation grooves in the axial direction.

The outer diameter of the shaft or the inner diameter of the sleeve may include at least one step formed in the axial direction.

The outer diameter of the shaft or the inner diameter of the sleeve may include at least one step formed between the first and second dynamic pressure generation grooves.

The lubricating fluid may move downwardly in the axial direction by a force formed by the first and second dynamic pressure generation grooves through the rotation of the shaft.

Each of the first and second dynamic pressure generation grooves may have at least one of a herringbone shape, a spiral shape, and a helical shape.

According to another aspect of the present invention, there is provided a spindle motor including the hydrodynamic bearing assembly as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor including a hydrodynamic bearing assembly according to an embodiment of the present invention;

FIG. 2 is a cut-away perspective view schematically showing the hydrodynamic bearing assembly according to the embodiment of the present invention;

FIG. 3 is a cross-sectional view showing a structure of a sleeve and a shaft according to a first embodiment of the present invention;

FIGS. 4A and 4B are cross-sectional views showing a structure of a sleeve and a shaft according to a second embodiment of the present invention;

FIG. 5 is a cross-sectional view showing a structure of a sleeve and a shaft according to a third embodiment of the present invention; and

FIG. 6 is a cross-sectional view showing a structure of a sleeve and a shaft according to a fourth embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components maybe exaggerated for clarity, and the same reference numerals will be used throughout to designate the same or like components.

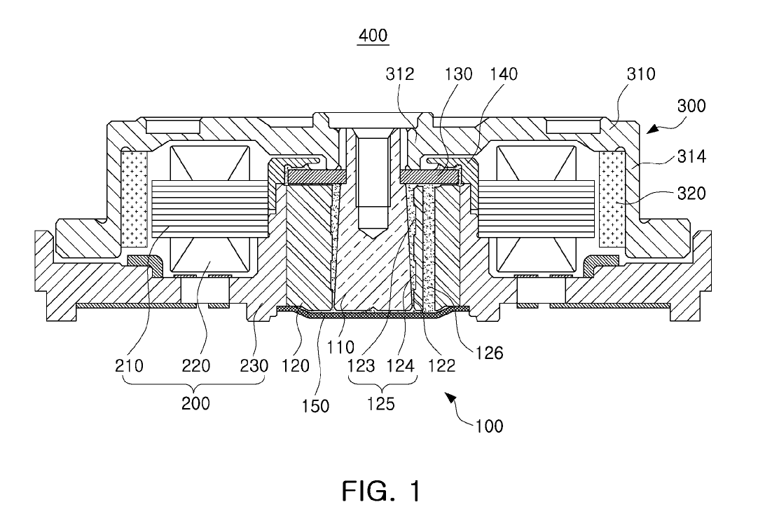

FIG. 1 is a cross-sectional view schematically showing a motor including a hydrodynamic bearing assembly according to an embodiment of the present invention.

Referring to FIG. 1, a motor 400 according to an embodiment of the present invention may include a hydrodynamic bearing assembly 100, a stator 200, and a rotor 300.

Embodiments of the hydrodynamic bearing assembly 100 will be described in detail below, and the motor 400 according to the embodiment of the present invention may have all the specific characteristics described in the individual embodiments of the hydrodynamic bearing assembly 100.

The stator 200 is a stationary structure including a winding coil 220 generating electromagnetic force having a predetermined magnitude when power is applied thereto and a plurality of cores 210 having the winding coil 220 wound therearound.

The core 210 is fixedly disposed on an upper portion of the base 230, on which a printed circuit board (not shown) having circuit patterns printed thereon is provided. A plurality of coil holes having a predetermined size may be formed to penetrate an upper surface of the base 230 corresponding to the winding coil 220 such that the winding coil 220 is exposed downwardly therethrough. The winding coil 220 maybe electrically connected to the printed circuit board (not shown) so that external power is supplied thereto.

Here, the base 230 configuring the stator 200 and the hydrodynamic bearing assembly 100 will be described in detail below.

The rotor 300 is a rotating structure that is rotatably provided with respect to the stator 200. The rotor 300 may include a rotor case 310 having an annular ring shaped magnet 320 provided on an inner peripheral surface thereof, the annular ring shaped magnet 320 corresponding to the core 210 while having a predetermined interval therebetween.

In addition, the magnet 320 is a permanent magnet that has north and south magnetic poles alternately arranged in a circumferential direction to generate magnetic force having a predetermined magnitude.

Here, the rotor case 310 may include a stationary part 312 press-fitted into an upper end of the shaft 110 to thereby be fixed thereto and a magnet support part 314 extended from the stationary part 312 in an outer diameter direction and bent downwardly in an axial direction to thereby support the magnet 320 of the rotor 300.

In addition, the spindle motor may include stationary members and rotating members rotating based on the stationary members. The stationary members may include the stator 200 and a sleeve 120 and a sealing cap 140 in the hydrodynamic bearing assembly 100 to be described below. In addition, the rotating members indicate all components except for the stationary members and may include the rotor 300 and a shaft 110 and a thrust plate 130 in the hydrodynamic bearing assembly 100.

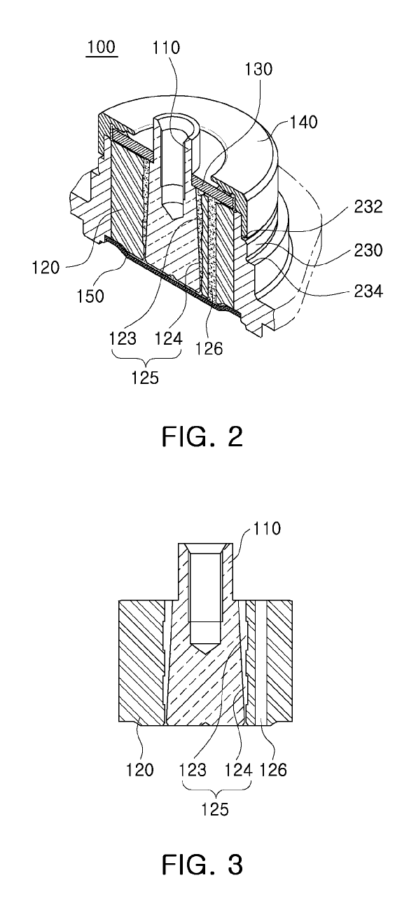

FIG. 2 is a cut-away perspective view schematically showing the hydrodynamic bearing assembly according to the embodiment of the present invention.

The hydrodynamic bearing assembly 100 according to the embodiment of the present invention may include the shaft 110, the sleeve 120, the thrust plate 130, the sealing cap 140, and the base 230.

Here, terms with respect to directions will be first defined. As viewed in FIG. 2, an axial direction refers to a vertical direction based on the shaft 110 and an outer diameter direction or an inner diameter direction refers to a direction toward an outer edge of the rotor 300 based on the shaft 110 or a direction toward the center of the shaft 110 based on the outer edge of the rotor 300.

The sleeve 120 may support the shaft 110 such that the upper end of the shaft 110 protrudes upwardly in the axial direction, and may be formed by forging Cu or Al or sintering Cu-Fe based alloy powders or SUS based powders.

Here, the shaft 110 is inserted into a shaft hole 122 of the sleeve 120 with a micro clearance (a bearing clearance) therebetween. The micro clearance is filled with a lubricating fluid. The rotation of the rotor 300 may be more smoothly supported by a dynamic pressure generation groove 125 formed in at least one of an outer diameter of the shaft 110 and an inner diameter of the sleeve 120.

The dynamic pressure generation groove 125 is formed in an inner surface of the sleeve 120, which is an inner portion of the shaft hole 122 of the sleeve 120, and generates pressure so as to be deflected in a certain direction at the time of rotation of the shaft 110.

However, the dynamic pressure generation groove 125 is not limited to being formed in the inner surface of the sleeve 120 as described above but may also be formed in an outer diameter portion of the shaft 110. In addition, the number of dynamic pressure generation grooves 125 is not limited.

Further, according to the embodiment of the present invention, the dynamic pressure generation groove 125 may include first and second dynamic pressure generation grooves 123 and 124 that generate dynamic pressure in the lubricating fluid filling the bearing clearance between the shaft 110 and the sleeve 120 at the time of rotation of the shaft 110 and have at least one of a herringbone shape, a spiral shape, and a helical shape. Although two dynamic pressure generation grooves are shown in the accompanying drawings, the invention is not limited thereto. That is, as described above, the number of dynamic pressure generation grooves is not limited.

The dynamic pressure generation grooves 125 are formed in the upper and lower portions of the sleeve in the axial direction, such that the shaft 110 may rotate while being accurately centered.

Here, in order to improve bearing strength directly associated with the perpendicularity of the shaft 110, a method of maximally increasing an interval between the first and second dynamic pressure generation grooves 123 and 124 to thereby increase a length of the bearing or a method of reducing an interval between the shaft and the sleeve or a groove depth of the journal bearing may be used.

Meanwhile, the lubricating fluid may be excessively pumped to the first and second dynamic pressure generation grooves 123 and 124, due to vibrations, external impacts, or the like, at the time of driving of the motor, such that negative pressure may be generated between the first and second dynamic pressure generation grooves 123 and 124. Therefore, according to the embodiment of the present invention, in order to prevent the generation of negative pressure, the bearing clearance between the shaft 110 and the sleeve 120 is narrowed downwardly in the axial direction, thereby preventing the lubricating fluid from being excessively pumped to the lower dynamic pressure generation groove 124, whereby the generation of negative pressure may be reduced. Detailed embodiments will be described below with reference to FIGS. 3 through 6.

The sleeve 120 may include a bypass channel 126 formed therein so as to allow upper and lower portions thereof to communicate with each other, to disperse pressure from the lubricating fluid in an inner portion of the hydrodynamic bearing assembly 100, thereby maintaining a balance in pressure, and may move air bubbles, or the like, existing in the inner portion of the hydrodynamic bearing assembly 100 so as to be discharged by circulation.

The thrust plate 130 is disposed on an upper portion of the sleeve 120 in the axial direction and includes a hole corresponding to a diameter of the shaft 110 at the center thereof, wherein the shaft 110 may be inserted into the hole.

Here, the thrust plate 130 may be separately manufactured and then coupled to the shaft 110. However, the thrust plate 130 may be formed integrally with the shaft 110 at the time of manufacturing thereof. The thrust plate 130 may rotate together with the shaft 110 at the time of the rotation of the shaft 110.

In addition, the thrust plate 130 may include a thrust dynamic pressure generation groove formed in an upper surface thereof, and the thrust dynamic pressure generation groove provides thrust dynamic pressure to the shaft 110.

The thrust dynamic pressure generation groove is not limited to being formed in the upper surface of the thrust plate 130 as described above, but may also be formed in an inner peripheral surface of the sealing cap 140 to be described below corresponding to the upper surface of the thrust plate 130.

The sealing cap 140 is press-fitted to an upper portion of the thrust plate 130 to allow the lubricating fluid to be sealed between the thrust plate 130 and the sealing cap 140. An outer peripheral surface of the base 230 may be inserted into the sealing cap 140 to thereby be supported by the sealing cap 140.

The sealing cap 140 may include a protrusion part formed on a lower surface thereof in order to seal the lubricating fluid, which uses a capillary phenomenon in order to prevent the lubricating fluid from being leaked to the outside at the time of the driving of the motor.

The sealing cap 140 may have a larger diameter B in an inner peripheral surface thereof contacting the base 230 than a diameter A in an inner peripheral surface thereof contacting an outer peripheral surface of the thrust plate 130 so as to be seated on the upper portion of the sleeve 120 in the axial direction.

This is to allow an outer peripheral surface of the sealing cap 140 and the outer peripheral surface of the base 230 to coincide with each other and is consequently to stably press-fit the core 210 having the coil 220 wound therearound to the outer peripheral surfaces of the sealing cap 140 and the base 230.

Therefore, the outer peripheral surface of the base 230 has a shape corresponding to that of the sealing cap 140. That is, the outer peripheral surface of the base 230 has a variable diameter.

Here, the sealing cap 140 is press-fitted to the outer peripheral surface of the base 230, such that the diameter of the sleeve 120 may be substantially reduced.

This reduces an inner diameter of the core 210 press-fitted to the base 230 to thereby naturally increase a teeth length of the core 210 around which the coil 220 is wound.

Therefore, turns of the coil 220 wound around the core 210 are increased, such that the performance and dynamic stability of the hydrodynamic bearing assembly 100 may be improved.

The base 230 may be press-fitted to the outer peripheral surface of the sleeve 120 to thereby be fixed thereto and include the core 210 having the coil 220 wound therearound inserted thereinto. In addition, the base 230 may be assembled with the sleeve 120 by applying an adhesive to the inner surface of the base 230 or the outer surface of the sleeve 120.

The outer peripheral surface of the base 230 includes two-stage steps having a diameter increasing in the outer diameter direction and includes the sealing cap 140 and the core 210 respectively press-fitted onto the steps.

A first step portion 232 may allow the outer peripheral surface of the sealing cap 140 and the outer peripheral surface of the base 230 in contact with the core 210 to coincide with each other, such that the sealing cap 140 may stably be fixed to the base 230.

In addition, a second step portion 234 may fixedly support the core 210. A length of the second step portion 234 protruding in the outer diameter direction is not limited as long as the second step portion may stably support the core 210.

Therefore, since the outer peripheral surface of the base 230 has a variable diameter and the sealing cap 140 is press-fitted thereto, the diameter of the sleeve 120 may be reduced as compared to a case in which the sealing cap 140 is press-fitted to the sleeve 120. As a result, the teeth length of the core 210 may be increased.

A base cover 150 may be coupled to the lower portion of the sleeve 120 in the axial direction, having a clearance therebetween, and may have an outer diameter larger than that of the sleeve 120.

The base cover 150 may receive the lubricating fluid in the clearance between the sleeve 120 and the base cover 150 to thereby serve as a bearing supporting the lower surface of the shaft 110.

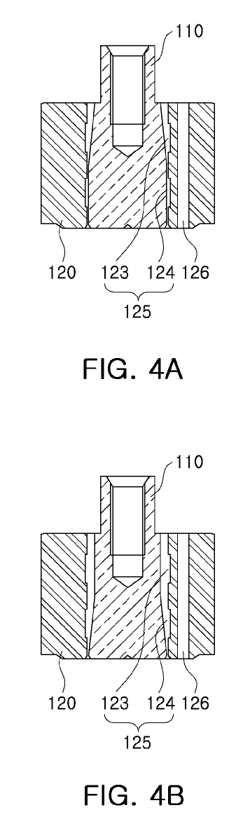

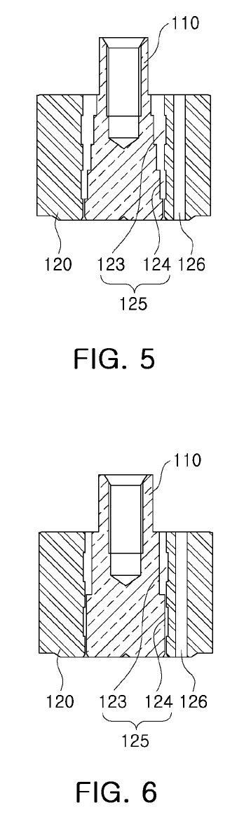

FIG. 3 is a cross-sectional view showing a structure of a sleeve and a shaft according to a first embodiment of the present invention; FIGS. 4A and 4B are cross-sectional views showing a structure of a sleeve and a shaft according to a second embodiment of the present invention; FIG. 5 is a cross-sectional view showing a structure of a sleeve and a shaft according to a third embodiment of the present invention; and FIG. 6 is a cross-sectional view showing a structure of a sleeve and a shaft according to a fourth embodiment of the present invention.

The hydrodynamic bearing assembly according to the embodiment of the present invention includes the shaft 110, the sleeve 120 including the shaft hole so that the shaft 110 is rotatably inserted thereinto, and the first and second dynamic pressure generation grooves 123 and 124 formed in at least one of the outer diameter of the shaft 110 and the inner diameter of the sleeve 120 and provided in the upper and lower portions thereof in the axial direction so as to generate dynamic pressure in the lubricating fluid filling the bearing clearance formed between the shaft 110 and the sleeve 120 at the time of rotation of the shaft 110. The bearing clearance between the shaft 110 and the sleeve 120 may be narrowed downwardly in the axial direction.

Referring to FIG. 3, in a structure of the sleeve 120 and the shaft 110 according to the first embodiment of the present invention, an outer diameter of the shaft 110 inserted into the shaft hole of the sleeve 120 may be entirely tapered. That is, the shaft 110 has a diameter increasing from an upper portion thereof toward a lower portion thereof and the shaft hole of the sleeve 120 has a constant diameter, such that the bearing clearance may be narrowed downwardly in the axial direction.

Alternatively, although not shown, the shaft 110 may have a constant outer diameter and the shaft hole of the sleeve 120 may have an inner diameter reducing downwardly in the axial direction, such that the bearing clearance may be narrowed downwardly in the axial direction.

Referring to FIGS. 4A and 4B, in a structure of the sleeve 120 and the shaft 110 according to the second embodiment of the present invention, an outer diameter of the shaft 110 inserted into the shaft hole of the sleeve 120 may be partially tapered. That is, the shaft 110 has a diameter increasing from a predetermined portion thereof toward a lower portion thereof and the shaft hole of the sleeve 120 has a constant diameter, such that the bearing clearance may be narrowed downwardly in the axial direction. Here, the tapered portion may be formed from an upper end of the shaft 110 to a portion between the first and second dynamic pressure generation grooves 123 and 124 (See FIG. 4A). Alternatively, the tapered portion may be formed from a portion between the first and second dynamic pressure generation grooves 123 and 124 to a lower end of the shaft 110 (See FIG. 4B).

Meanwhile, although not shown, the shaft 110 has a constant outer diameter and the shaft hole of the sleeve 120 has an inner diameter reducing from a predetermined portion of the shaft hole downwardly in the axial direction, such that the bearing clearance may be narrowed downwardly in the axial direction.

Referring to FIG. 5, in a structure of the sleeve 120 and the shaft 110 according to the third embodiment of the present invention, the shaft 110 inserted into the shaft hole of the sleeve 120 may include at least one step formed in an outer diameter thereof. That is, the shaft 110 has a diameter increasing from an upper portion thereof toward a lower portion thereof by the step and the shaft hole of the sleeve 120 has a constant diameter, such that the bearing clearance may be narrowed downwardly in the axial direction. Here, at least one or more steps may be provided.

Alternatively, although not shown, the shaft 110 has a constant outer diameter and the shaft hole of the sleeve 120 includes a step formed in an inner diameter thereof, such that the bearing clearance may be narrowed downwardly in the axial direction.

Referring to FIG. 6, in a structure of the sleeve 120 and the shaft 110 according to the fourth embodiment of the present invention, the shaft 110 inserted into the shaft hole of the sleeve 120 may include at least one step formed in an outer diameter thereof. That is, the shaft 110 includes a step formed in a predetermined portion thereof to have a diameter reducing downwardly in the axial direction by the step and the shaft hole of the sleeve 120 has a constant diameter, such that the bearing clearance may be narrowed downwardly in the axial direction. Here, the predetermined portion in which the step is formed may be positioned between the first and second dynamic pressure generation grooves 123 and 124. In addition, at least one step may be formed under the predetermined portion.

Alternatively, although not shown, the shaft 110 has a constant outer diameter and the shaft hole of the sleeve 120 includes a step formed in an inner diameter thereof, such that the bearing clearance may be narrowed downwardly in the axial direction.

As described in the above-mentioned embodiments, the bearing assembly capable of minimizing the generation of negative pressure in the spindle motor may be provided. In addition, since the structures of the bearing assembly according to the embodiments of the present invention may be simply manufactured through simple modification of a manufacturing scheme, a manufacturing line according to the related art may be used as it is.

As set forth above, according to embodiments of the present invention, a motor may have improved performance by preventing the generation of negative pressure in a hydrodynamic bearing assembly.

In addition, the motor may be stably used even when vibrations, external impacts, and the like, are applied thereto.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a shaft;
a sleeve including a shaft hole so that the shaft is rotatably inserted thereinto; and
first and second dynamic pressure generation grooves formed in upper and lower portions of at least one of an outer diameter of the shaft and an inner diameter of the sleeve in an axial direction thereof so as to generate dynamic pressure in a lubricating fluid filling a bearing clearance formed between the shaft and the sleeve at the time of rotation of the shaft,
wherein the bearing clearance between the shaft and the sleeve is narrowed downwardly in the axial direction.

2. The hydrodynamic bearing assembly of claim 1, wherein the outer diameter of the shaft or the inner diameter of the sleeve is tapered in the axial direction.

3. The hydrodynamic bearing assembly of claim 1, wherein the outer diameter of the shaft or the inner diameter of the sleeve is tapered downwardly from a portion between the first and second dynamic pressure generation grooves in the axial direction.

4. The hydrodynamic bearing assembly of claim 1, wherein the outer diameter of the shaft or the inner diameter of the sleeve includes at least one step formed in the axial direction.

5. The hydrodynamic bearing assembly of claim 1, wherein the outer diameter of the shaft or the inner diameter of the sleeve includes at least one step formed between the first and second dynamic pressure generation grooves.

6. The hydrodynamic bearing assembly of claim 1, wherein the lubricating fluid moves downwardly in the axial direction by a force formed by the first and second dynamic pressure generation grooves through the rotation of the shaft.

7. The hydrodynamic bearing assembly of claim 1, wherein each of the first and second dynamic pressure generation grooves has at least one of a herringbone shape, a spiral shape, and a helical shape.

8. A spindle motor comprising the hydrodynamic bearing assembly of claim 1.
